(19) United States
(12) Patent Application Publication
(10) Pub. No.: US 2017/0357934 A1
(43) Pub. Date: Dec. 14, 2017

(54) RETAIL AUTOMOTIVE DEALERSHIP INVENTORY TRACKING, RECONCILIATION AND WORKFLOW SYSTEM

(71) Applicant: CP Handheld Technologies, LLC, Fort Lauderdale, FL (US)

(72) Inventors: Johnathan D. Cobb, Newburgh, IN (US); Daniel Perry, Fort Lauderdale, FL (US); Eric W. Rudisill, Newburgh, IN (US)

(73) Assignee: CP Handheld Technologies, LLC, Fort Lauderdale, FL (US)

(21) Appl. No.: 15/180,945

(22) Filed: Jun. 13, 2016

(51) Int. Cl. G06Q 10/08; G06K 7/10; G06K 19/077

(52) U.S. Cl. CPC G06Q 10/087; G06K 19/07764; G06K 7/10366

(57) ABSTRACT

The present invention provides vehicle dealerships with an UWB enabled smart tag that is installed on the vehicle's windshield. The smart tag broadcasts its location via UWB on a predetermined schedule or as a response to movement. The smart tags location is determined by UWB anchors which use MLAT to localize the tag. The present invention allows dealership personnel to more accurately mange their inventory. The present invention allows banks and lending institutions to more accurately ascertain physical location of vehicles that are floor planed. The present invention results in lower total cost of operations for the dealership. The present invention takes the practices of a timely accurate physical inventory reconciliation puts them into real-time perpetuity of the dealership's operations. The present invention reduces time to market by automating the workflow of vehicles at a dealership.

### BACKGROUND OF THE INVENTION

### Field of the Invention

The present invention relates generally to the field of real-time asset tracking via proprietary Ultra Wide Band (UWB) radio frequency technology. More specifically, the present invention relates to a real-time asset tracking, reconciliation and workflow system for use in the retail automotive industry.

### Description of Prior Art

Automobile dealerships are challenged with the laborious task of managing large inventories. As a result, corresponding dealerships are unable to produce timely, accurate inventory reconciliations, thus degrading the integrity of the information. Outdated inventory reports can cause many problems for the dealership as it relates to manufacturer, floor plan credit, incentives, theft, and credibility to the customer. There are many cases of inaccurate reporting of assets that may under or overstate the dealership's balance sheet and credit worthiness that expose all parties responsible for signing financials. These issues are exacerbated by the increasing number of vehicles on the lot and their availability through resellers via online auction houses and listings.

An increasing factor contributing to this problem are the number of vehicles for sale and the short turnover period. What used to be a 90 day carrying cycle can easily be cut to 60 to 45 based upon buying patterns of internet sales. Moreover, the customers are armed with a wealth of knowledge and alternatives to the vehicles available at the dealership. Inaccurate information will result in a customer purchasing elsewhere.

Automobile dealerships process new and used vehicles prior to having the vehicles ready for sale. The processing can vary for each vehicle, or consist of standard processing steps for each vehicle. Keeping track of the steps needed and completed to process each vehicle is an information challenge. The work performed requires data such as: when the vehicle arrived on premises; who checked-in the vehicle and set its process path; what process steps are variable for each vehicle versus the standard path for get-ready; and when is the vehicle ready for sale. Unison is a workflow software which easily captures this data and makes logical reports and sends alerts when bottleneck parameters are exceeded. Unison along with tracking the movement and time of each vehicle provides a solution to the processing management challenges, including reports, vendor involvement, and accounting integration, resulting in ideal software for the job.

### SUMMARY OF THE INVENTION

The present invention provides automotive dealerships with a smart network of tags that are installed on the vehicle's windshield. The smart tag transmits the Vehicle Identification Number (VIN) and location data to a centralized base station via a combination of Ultra Wide Band (UWB) and 2.4 GHz wireless technologies. A network of UWB and 2.4 GHz enabled anchors calculate location data and relay this data to a centralized basestation. Each anchor is capable of communicating and relaying information on behalf of other anchors. Hence, the information from anchor A could be derived from anchors X, Y and Z. The tags in consort with the anchors are capable of localizing an accurate position using an array of Multilateration (MLAT) technologies. The MLAT method used is defined by the best fit for the particular deployment. The base station, in turn, transmits all vehicle location data to a web based application via a cellular connection. This minimizes the amount of infrastructure required to deploy a turnkey solution. The present invention provides personnel with real-time information on the availability and location of any vehicle on the lot. This information can be accessed via API, web browser, cell phone, tablet or other mobile computing platform.

According to one presently preferred embodiment of the invention, there is provided an inventory tracking, reconciliation and work flow system for use in connection with motor vehicles comprising a locator tag associated with a motor vehicle, a plurality of anchors and a base station. The locator tag may include one or more sensors for detecting and gathering location and movement information and a transceiver configured to transmit said location and movement information. Each anchor may include a first transceiver for communicating with the locator tag transceiver to receive said location and movement information, and a second transceiver for communicating with the other anchors to form a resilient network. The base station may include a first transceiver for communicating with the second transceivers of the plurality of anchors to receive said location and movement information, and means for relaying said location and movement information to an application for processing said location and movement information.

The resilient network may be a wireless mesh network. The plurality of anchors preferably includes at least three anchors. The locator tag transceiver and the first transceiver of each of the plurality of anchors are preferably ultra wide band transceivers, and the second transceiver of each of the plurality of anchors and the first base station transceiver are preferably 2.4 GHz wireless transceivers. The means for relaying may comprise a cellular transceiver.

According to a further aspect of this embodiment of the present invention each anchor further includes an inertial motion sensor. The inertial motion sensor may comprise a 3-axis accelerometer, a 3-axis gyroscope and a 3-axis magnetometer. Each anchor may further include an altimeter/barometer. The one or more locator tag sensors may also include an inertial motion sensor, which may also comprise a 3-axis accelerometer, a 3-axis gyroscope and a 3-axis magnetometer. Each locator tag may further includes an altimeter/barometer.

The inventory tracking, reconciliation and work flow system according this embodiment may further include an adhesive backing having an upper reflective surface engaging the locator tag and a lower surface configured to engage a windshield of the vehicle. The one or more locator tag sensors comprise an infrared emitter and detector facing and tuned to the reflective surface engaging the locator tag to reflect a particular spectrum of light.

A weatherproof housing encasing the locator tag may also be provided according to the invention. A lower section of the housing is disposed between the infrared emitter and detector and the upper reflective surface of the adhesive backing. The lower housing may be formed of an infrared transmissive polycarbonate material that allows the emitted infrared light from the infrared emitter to pass through the housing and reflect back from the upper reflective surface. Observation or removal of the adhesive backing is detected by the infrared detector and triggers a notification to the resilient network.

According to another presently preferred embodiment of the invention, there is provided an inventory tracking, reconciliation and work flow system for use in connection with motor vehicles comprising location means, tamper-resistant means and security means. The location means are provided for transmitting a signal for determining the location of a vehicle when a locator tag associated with a motor vehicle detects movement of the vehicle or at a predetermined timeout interval. The tamper-resistant means are configured to transmit a signal for determining whether a locator tag has been tampered with when a locator tag associated with a motor vehicle detects that the locator tag has been separated from the vehicle The security means are provided for transmitting a signal when unauthorized movement of a vehicle is detected.

The location means may further comprise a plurality of anchors, each anchor having a first transceiver for communicating with a transceiver of the locator tag to receive location information, and a second transceiver for communicating with the other anchors to form a resilient network. The locator tag transceiver and the first transceiver of each of the plurality of anchors are preferably ultra wide band transceivers. The location means may further comprise a base station having a first transceiver for communicating with the second transceivers of the plurality of anchors to receive said location information, and means for relaying said location information to an application for processing said location information. The second transceiver of each of the plurality of anchors and the first base station transceiver are preferably 2.4 GHz wireless transceivers.

The tamper-resistant means may further comprise an adhesive backing having an upper reflective surface engaging the locator tag and a lower surface configured to engage a windshield of the vehicle. The one or more locator tag sensors may include an infrared emitter and detector facing and tuned to the reflective surface engaging the locator tag to reflect a particular spectrum of light.

A weatherproof housing encasing the locator tag may also be provided according to the invention. A lower section of the housing is disposed between the infrared emitter and detector and the upper reflective surface of the adhesive backing. The lower housing may be formed of an infrared transmissive polycarbonate material that allows the emitted infrared light from the infrared emitter to pass through the housing and reflect back from the upper reflective surface. Observation or removal of the adhesive backing is detected by the infrared detector and triggers a notification to the resilient network.

The security means may further comprise a plurality of anchors, each anchor having a first transceiver for communicating with a transceiver of the locator tag to receive movement information, and a second transceiver for communicating with the other anchors to form a resilient network. The locator tag transceiver and the first transceiver of each of the plurality of anchors are preferably ultra wide band transceivers. The security means may further include a base station having a first transceiver for communicating with the second transceivers of the plurality of anchors to receive movement information, and means for relaying said movement information to an application for processing said movement information. The second transceiver of each of the plurality of anchors and the first base station transceiver are preferably 2.4 GHz wireless transceivers.

The security means may further comprise an internal motion sensor associated with each anchor. The inertial motion sensor may comprise a 3-axis accelerometer, a 3-axis gyroscope and a 3-axis magnetometer. The security means may further include an altimeter/barometer associated with each anchor. The security means may further comprise an internal motion sensor associated with each one or more locator tag sensors. The inertial motion sensor may comprise a 3-axis accelerometer, a 3-axis gyroscope and a 3-axis magnetometer. The security means may further includes an altimeter/barometer associated with each locator tag.

These and other features, aspect and advantages of the present invention will become clearer by reviewing the drawings and detailed description herein.

### BRIEF DESCRIPTION OF THE DRAWINGS

FIG. 1 is a functional block diagram of an exemplary system for identifying and tracking the presence and location of one or more vehicles on a lot according to the invention.

FIG. 2 is a block diagram of a base station of the system for identifying and tracking the presence and location of one or more vehicles shown in FIG. 1.

FIG. 3 is a block diagram of an anchor of the system for identifying and tracking the presence and location of one or more vehicles shown in FIG. 1.

FIG. 4 is a block diagram of a locator tag of the system for identifying and tracking the presence and location of one or more vehicles shown in FIG. 1.

FIG. 5A is an exploded top perspective view of the locator tag and associated housing of the system for identifying and tracking the presence and location of one or more vehicles shown in FIG. 1.

FIG. 5B is an exploded bottom perspective view of the locator tag and associated housing of the system for identifying and tracking the presence and location of one or more vehicles shown in FIG. 1.

### DETAILED DESCRIPTION OF PREFERRED EMBODIMENTS

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

The present invention is comprised of several components and subsystems which makeup the entire invention. The present invention provides long and short range radio frequency tags 40a, 40b, 40c for use by retail automotive dealerships and auction facilities that all allows them to locate vehicles 110a, 110b, 110c in real-time. Conveniently, a comptroller may employ the present invention to locate a vehicle that is showing up as a discrepancy in accounting. In one particular embodiment, the present invention is capable of locating the discrepancy on an offsite lot. Not only is this system useful for detecting the presence of a vehicle 110 on the lot 100, but it can also be used to determine the location of a vehicle 110 on the lot 100 and its proximity to or presence at a particular station, such as inspection station 50, detailing station 52 or sales station 54.

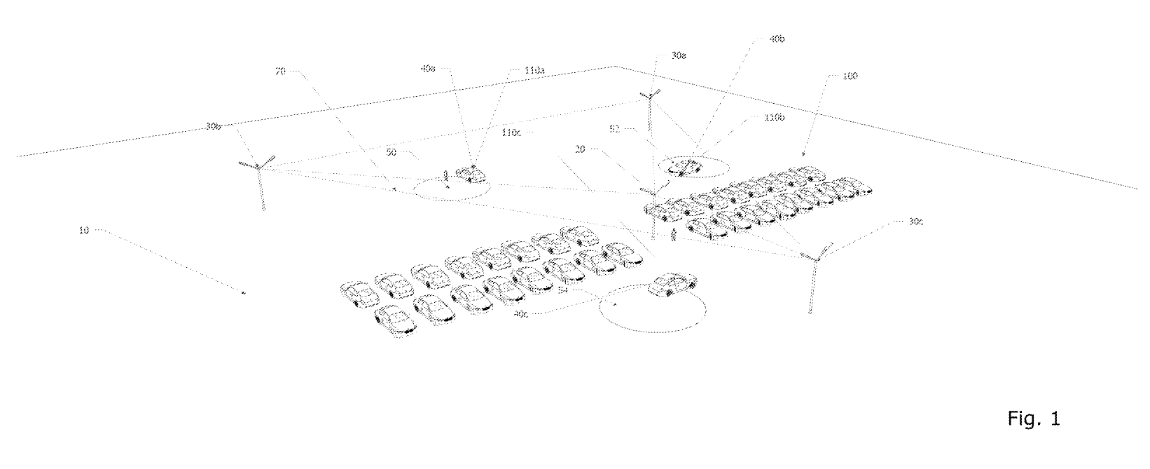

FIG.1 shows one preferred embodiment of an inventory tracking, reconciliation and workflow system 10 used in connection with one or more vehicles 110a, 110b, 100c, etc. on a lot 100 of a retail automotive dealership. The system 10 includes a base station 20, a plurality of anchors, preferably at least three (3) anchors 30a, 30b, 30c, and one or more locator tags 40a, 40b, 40c, etc. associated with corresponding one or more vehicles 110a, 110b, 100c, etc.

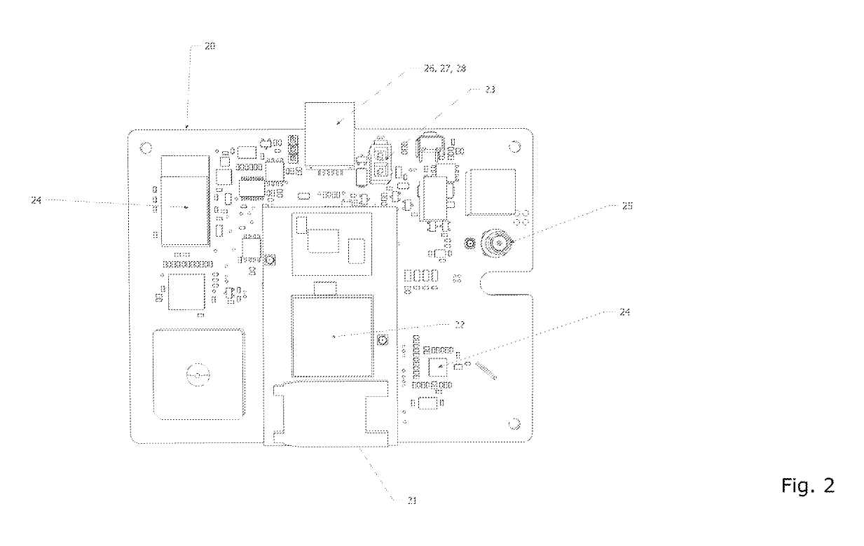

As best shown in FIG. 2, the base station 20 is comprised of a cellular transceiver 22 and 2.4 GHz wireless transceiver 24 that relay received messages from one or more of the anchors 30a, 30b, 30c to the web based application. The base station 20 may be positioned anywhere on or off the lot 100 so long as it is in range of one or more of the anchors 30a, 30b, 30c. Preferably, the base station is positioned at a central location or in an office building on the lot 100. The base station 20 also includes a micro-controller 21 coupled to and controlling the cellular transceiver 22 and wireless transceiver 24. The base station 20 receives power via a power input 23. Alternative means for transmitting the data to a remote server, such as antenna 25, USB 26, CANbus 27 and/or Ethernet 28 connectors may also be provided.

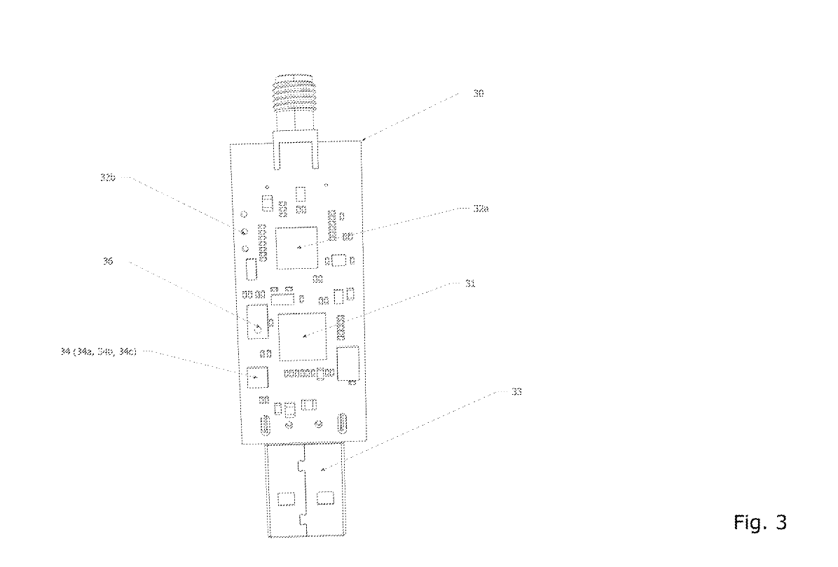

The three or more anchors 30a, 30b, 30c are positioned at locations remote from one another on the lot 100. As best shown in FIG. 3, each anchor 30 includes an ultra-wide band (UWB) transceiver 32a and 2.4 GHz wireless transceiver 32b that participate in the calculation of location of the tags 40a, 40b, 40c. The anchors 30a, 30b, 30c participate in a mesh network 60 which is responsible for reliably transmitting vehicle location to the base station 20. The anchor 30 also includes a micro-controller 31 which is coupled to the UWB transceiver 32a and the wireless transceiver 32b. The anchor 30 receives power via a power input 33.

Each anchor 30 may also include a 9-axis inertial motion sensor 34, which includes a 3-axis accelerometer 34a, a 3-axis gyroscope 34b, and a 3-axis magnetometer 34c. The accelerometer 34a and gyroscope 34b provide information about accelerations in all three directions, and rotations around each axis. To account for drift due to the build up of small errors in each axis over time, a magnetometer 34c is also included to track the absolute change in position and orientation much more accurately. Alternatively, the inertial motion sensor 34 may consist of an attitude and heading reference system (AHRS) that consists of sensors on three axes that provide attitude information including roll, pitch and yaw. The AHRS may consist of either solid-state or microelectromechanical systems (MEMS) gyroscopes, accelerometers and magnetometers on all three axes. Each anchor 30 also includes an altimeter/barometer 36 may also be connected to the micro-controller 31 to provide data with regard to the altitude of the anchor 30. This information is particularly useful where vehicles are located in a multi-level parking garage or similar facility.

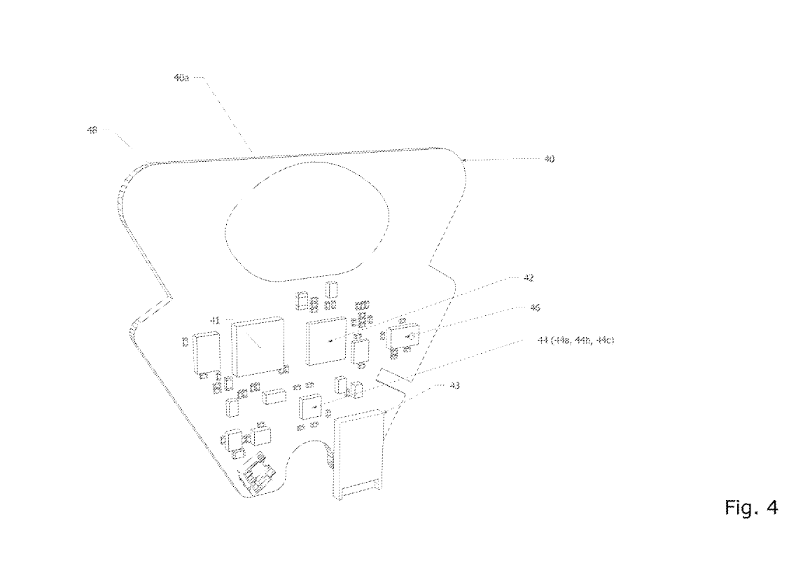

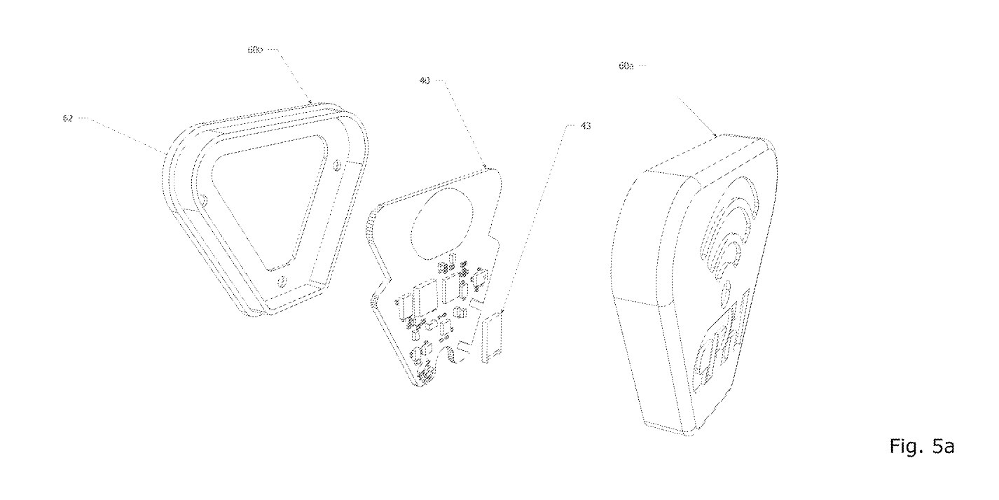

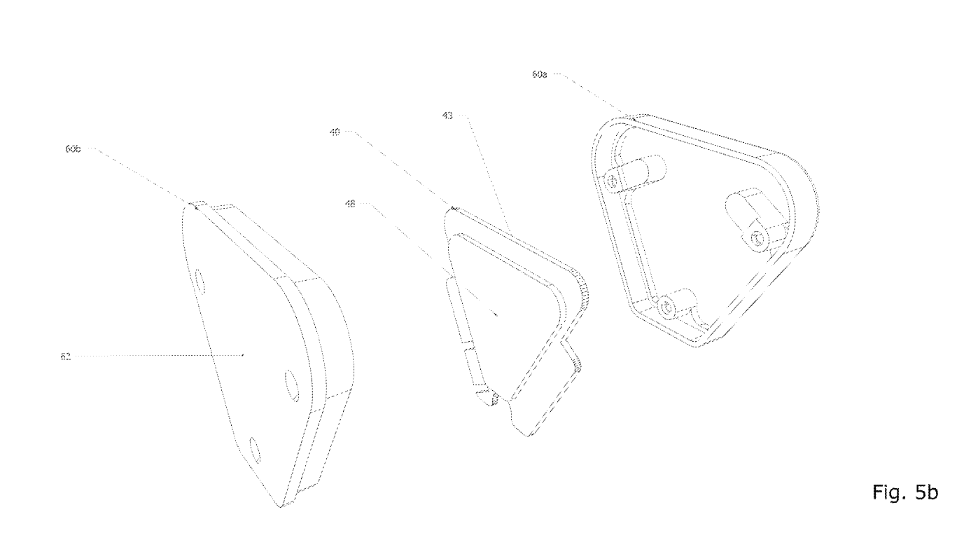

Each vehicle 110 is fitted with a locator tag 40 which is used to track the presence and location of the vehicle 110 on the lot 100. The locator tag 40 is the device that is affixed to the vehicle 110 and is responsible for beaconing location and movement information. The tag is equipped with a wide array of sensors to notify of theft, tampering movement, and abuse. As best shown in FIG. 4, the locator tag 40 includes a micro-controller 41, preferably an Atmel SAM4S Cortex-M4 micro-controller, that communicates with several onboard subsystems, including at least a tampering subsystem, a security subsystem, and a location subsystem. The micro-controller 41 is coupled to a UWB transceiver 42 which is configured to transmit location and movement information to the one or more of the anchors 30a, 30b, 30c. The micro-controller 41 and other components of the locator tag 40 receive power via a battery 43. As best shown in FIG. 5B, the battery may preferably be a coin-cell type battery, which, in the present setting, has an expected life of approximately six (6) months.

The tampering sub system is comprised of an infrared emitter and detector 48 that is tuned to an adhesive backing 62 that reflects a particular spectrum of light. The adhesive backing 52 also affixes the locator tag 40 to the windshield. As best shown in FIG. 5A and FIG. 5B, the locator tag 40 is located within a weatherproof housing 60 having an upper housing 60a and a lower housing 60b. The housing 60 is formed of a material that is impact and water resistant. Preferably, a material that is rated IP67 or higher is used to protect the locator tag 40 from dust and against the effect of immersion between 15 cm and 1 m. The lower housing 60b is preferably formed of an infrared transmissive polycarbonate material that allows the emitted infrared light from the infrared emitter 48 to pass through the bottom of the case and to reflect back from the adhesive 62. Obscuration or removal of the adhesive 62 is detected by the infrared detector 48 and triggers a notification to the network 70.

The security subsystem is comprised of a 9-axis inertial motion sensor 44, which includes a 3-axis accelerometer 44a, a 3-axis gyroscope 44b, and a 3-axis magnetometer 44c. The accelerometer 44a and gyroscope 44b provide information about accelerations in all three directions, and rotations around each axis. To account for drift due to the build up of small errors in each axis over time, a magnetometer 44c is also included to track the absolute change in position and orientation much more accurately. The components of the security subsystem can also act to extend battery life by shutting down power to the systems of the locator tag 40 when movement has not been detected for a predetermined period of time. Alternatively, the inertial motion sensor 44 may consist of an attitude and heading reference system (AHRS) that consists of sensors on three axes that provide attitude information including roll, pitch and yaw. The AHRS may consist of either solid-state or microelectromechanical systems (MEMS) gyroscopes, accelerometers and magnetometers on all three axes. The locator tag 40 may also include an altimeter/barometer 46 may also be connected to the micro-controller 41 to provide data with regard to the altitude of the locator tag 40 and the corresponding vehicle 110. This information is particularly useful where vehicles are located in a multi-level parking garage or similar facility.

The security subsystem works in consort with the tampering subsystem to determine removal of the tag 40. The security subsystem is also responsible for reporting vehicle movement as well as hard braking and acceleration. The security subsystem is capable of detecting vehicle motion, including opening and closing of doors to determine access to the vehicle, or inclination and declination of vehicle in the scenario where wheels and tires may be stolen. The components of the security subsystem may also be used to measure and log hard braking and acceleration to determine vehicle abuse. Motion is used to determine reporting interval of the tag in order to conserve battery life. Motion sensing is used in consort with the IR sensor to detainee tag tampering in the event the tag is removed from the vehicle.

The location subsystem is comprised of a UWB radio transceiver 42 which is responsible for transmitting a beacon when the vehicle senses movement and or predetermined timeout interval whichever occurs first. This beacon is used to calculate the exact location of the tag 40 relative to the anchors 30a, 30b, 30c.

The anchors 30a, 30b, 30c are capable of meshing together with one another, and with the base station 20 to form a wireless mesh network (WMN) 70, wherein one anchor 30a is capable of relaying information on behalf of other anchors 30b, 30c. When a specific vehicle on the network transmits its location the route to the base station 20 may change. The mesh network 70 created from a number of anchors 30a, 30b, 30c acts as a resilient network to guarantee delivery of the information. The purpose of this functionality is to expand the footprint of the network, extend battery life and ensure self repairing/healing of less dense areas of the network. The mesh created by present invention also acts as a point to multi-point ranging field from which location of the asset can be ascertained via multilateration (MLAT).

The system is set up, or commissioned, by first placing the base station 20 at a location and then placing the three or more anchors 30a, 30b, 30c at locations on the lot 100. Initially, the coordinates of one of the anchors, primary anchor 30a for example, must be known. The primary anchor 30a then communicates with secondary anchor 30b and tertiary anchor 30c to determine the distances between each of the anchors, respectively.

The distances between anchors can be determined using a variety of known ranging methods including Time of Flight (TOF) ranging, two-way ranging, Time Difference of Arrival (TDOA), angle of arrival, or other MLAT techniques. Once the location of all three anchors 30a, 30b and 30c are determined, a satellite map may be overlaid onto the now known coordinates of the anchors and the locations of the various stations 50, 52, 54 determined.

Using MLAT, the location of a locator tag 40 is determined in two phases. MLAT is a two phase process where range measurements between a device with unknown location and three or more reference devices are used to estimate a location in two dimensions. The first phase involves measuring a relationship between nodes (e.g., distance and angle). The second phase uses these relationships to estimate location. Radio frequency (RF) received signal strength (RSS) measurements are commonly used to estimate range, but the accuracy of this technique is poor even in the best of conditions. Accordingly, the use of ultra-wideband (UWB) RF ranging is preferred. The second phase takes three or more of these ranges (for example, the ranges between anchor 30a and locator 40, between anchor 30b and locator 40, and between anchor 30c and locator 40) and, utilizing geometric computer algorithms, calculates the location of the locator 40. When used in connection with the present invention, UWB RF ranging can provide the location of the locator tag within 10 cm and can accurately detect locators at distances of 100 meters. The accuracy can be further enhanced by linking to a smartphone GPS.

Once the system has been commissioned, the locator tag 40 associated with each vehicle can be provisioned. In order to extend battery life, a locator tag 40 that is located on a vehicle 110 generally remains in a powered down state until activation is triggered. Activation can be triggered by an internal clock that would cause the locator tag 40 to transmit a signal at regular intervals, for example, every 10 seconds. The locator tag 40 can also be activated to transmit a signal when the inertial motion sensor 44 senses movement, or when the infra-red sensor 48 detects light indicating the housing 50 and/or mobile tag 40 has been tampered with. In the latter two instances, the signal would be transmitted at a higher frequency to indicate tampering or activity.

When the locator tag 40 is activated, it transmits an ultra wide band (UWB) RF signal which is received at each of the anchors 30a, 30b, 30c. Using one or more of the ranging techniques discussed above, the location of the locator tag 40 can be determined based, in part, on the distances between the locator tag 40 and each of the anchors 30a, 30b, 30c. One or more of the anchors 30a, 30b, 30c can then transmit the location information of the locator tag 40 to the location engine, which can either store the information about the locations of multiple locator tags. With the additional information provided by the satellite map overlay, algorithms can be created to determine whether a vehicle 100 having a locator tag 40 is at a particular station, such as inspection station 50, detailing station 52 or sales station 54.

The present invention provides a form of Peer to Peer n (P2Pn) Firmware Over The Air (FOTA) upgrades. This method of upgrading firmware allows the wave of firmware requests to be radiated outward from a cascading epicenter. As tags further from the epicenter become upgraded, they will source their FOTA records from tags in local proximity, thus propagating the wave until the entire network is upgraded.

Illustration A depicted below demonstrates how the tags receive firmware from neighboring anchors in the most efficient manner possible. Tag 0 has current firmware, each subsequent tag has one less line of firmware that they can request from the next closest anchor to the base station. This is a simple linear illustration that models how the tags would work in a network of many thousands.

Illustration A.

Tag 0: 1111111111

Tag 1: 1111111110

Tag 2: 1111111100

Tag 3: 1111111000

The present invention is capable of Firmware Over The Air (FOTA) upgrades. FOTA enables the smart tags to query neighboring devices for firmware versions. If neighboring tags have a newer version of firmware, a FOTA session is started and the new firmware is torrented from the neighboring tags internal flash. The reason for this feature is to minimize numerous downloads of firmware from the base station. Once the base station receives new firmware it is capable of broadcasting out the current version to all tags. This technology allows the mesh network to be self aware or upgraded on demand based upon commands received from the base station.

The present invention is capable of remote terminal sessions that allow system administrators to remotely communicate with the tags via the cellular base station. Network maintenance tuning can be achieved via the remote terminal.

### EXAMPLES

Example Reconciliation . . .

Managing large amounts of inventory is too laborious to manage all at once. The present invention allows dealerships to manage their inventories by exception in real-time. A perpetual view of exceptions is always available. Every possible real-time combination of cross-referenced exception via Physical, General Ledger, Floor Plan, Manufacturer, etc.

Example Workflow . . .

Vehicle processing poses many challenges for the dealership. The smart tag automatically provisions the vehicle into the dealership workflow system. The workflow system then triggers and delegates other tasks depending on the current state of the vehicle. For example, a new vehicle checking in may require PDI, booked to the general ledger, detail, etc. Vehicles departing premises for an offsite sale or storage may show up on a departure report that needs reconciliation. Unauthorized access to vehicles can trigger notifications to management.

Example Asset Validation . . .

Asset validation is one of most important points of risk mitigation for a dealership. Banks want to know the vehicles they are floor planning are physcially on the lot. Not having accurate inventories can cost the dealership their floorplan credit rating or banking relationship altogether. Dealerships need to know what cars are being driven in order to purchase more effieciently. Management needs to be alerted of suspicious activity.

Example Asset Location . . .

The monthly cycle of inventory always results in discrepancies. These discrepancies need to be tracked down by dealership personnel for asset validation purposes. The present invention provides personnel with the tools to quickly locate the vehicle on the lot or report to them that the vehicle has departed the premises. The present invention also helps sales associates to locate a particular vehicle inquiry by a customer.

Monthly floor plan reconciliations done by the bank require tracking down vehicles that are reported sold but still booked in inventory. The location services of the present invention speeds this process up tremendously.

As described above, according to a preferred embodiment of the present invention, the wireless communications use an 802.15.4-2011 based UWB radio. Alternatively, the RF transceiver could be a WiFi transceiver configured to transmit and receive data using IEEE 802.11 protocols; a Zigbee module configured to transmit and receive data using IEEE 802.15.4 protocols; a Bluetooth® low energy (BLE) transceiver or other equivalent RF transmission technology that may now, or in the future be utilized. As a further alternative, the wireless mesh network could consist of hardwiring between the various anchors and base station.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

1. An inventory tracking, reconciliation and work flow system for use in connection with motor vehicles comprising:
a locator tag affixed to a motor vehicle, said locator tag having one or more sensors for detecting and gathering location and movement information and a transceiver configured to transmit said location and movement information;
a plurality of anchors, each anchor being located in an area in which the locator tag and motor vehicle are expected to be located, and each anchor having a first transceiver for communicating with the locator tag transceiver to receive said location and movement information, and a second transceiver for communicating with the other anchors to form a resilient network; and
a base station having a first transceiver for communicating with the second transceivers of the plurality of anchors to receive said location and movement information, and means for relaying said location and movement information to an application for processing said location and movement information to verify that the vehicle is inventoried in the tracking, reconciliation and work flow system.

2. The inventory tracking, reconciliation and work flow system according to claim 1 wherein said resilient network is a wireless mesh network.

3. The inventory tracking, reconciliation and work flow system according to claim 1 wherein said plurality of anchors includes at least three anchors.

4. The inventory tracking, reconciliation and work flow system according to claim 1 wherein the locator tag transceiver and the first transceiver of each of the plurality of anchors are ultra wide band transceivers.

5. inventory tracking, reconciliation and work flow system according to claim 1 wherein the second transceiver of each of the plurality of anchors and the first base station transceiver are 2.4 GHz wireless transceivers.

6. The inventory tracking, reconciliation and work flow system according to claim 1 wherein the means for relaying comprises a cellular transceiver.

7. The inventory tracking, reconciliation and work flow system according to claim 1 wherein each anchor further includes an inertial motion sensor.

8. The inventory tracking, reconciliation and work flow system according to claim 7 wherein the inertial motion sensor comprises a 3-axis accelerometer, a 3-axis gyroscope and a 3-axis magnetometer.

9. The inventory tracking, reconciliation and work flow system according to claim 7 wherein each anchor further includes an altimeter/barometer.

10. The inventory tracking, reconciliation and work flow system according to claim 1 wherein said one or more locator tag sensors comprises an inertial motion sensor.

11. The inventory tracking, reconciliation and work flow system according to claim 10 wherein the inertial motion sensor comprises a 3-axis accelerometer, a 3-axis gyroscope and a 3-axis magnetometer.

12. The inventory tracking, reconciliation and work flow system according to claim 10 wherein each locator tag further includes an altimeter/barometer.

13. The inventory tracking, reconciliation and work flow system according to claim 1 further comprising an adhesive backing having an upper reflective surface engaging the locator tag and a lower surface configured to engage a windshield of the vehicle, wherein said one or more locator tag sensors comprises an infrared emitter and detector facing and tuned to the reflective surface engaging the locator tag to reflect a particular spectrum of light.

14. The inventory tracking, reconciliation and work flow system according to claim 13 further comprising a weatherproof housing encasing the locator tag, a lower section of said housing being disposed between said infrared emitter and detector and said upper reflective surface of the adhesive backing, said lower housing being formed of an infrared transmissive polycarbonate material that allows the emitted infrared light from the infrared emitter to pass through the housing and reflect back from the upper reflective surface.

15. The inventory tracking, reconciliation and work flow system according to claim 14 wherein observation or removal of the adhesive backing is detected by the infrared detector and triggers a notification to the resilient network.

16. An inventory tracking, reconciliation and work flow system for use in connection with motor vehicles comprising:
location means for transmitting a signal for determining the location of a vehicle when a locator tag affixed to the vehicle detects movement of the vehicle to verify that the vehicle is inventoried in the tracking, reconciliation and work flow system or at a predetermined timeout interval;
tamper-resistant means for transmitting a signal for determining whether said locator tag has been tampered with when said locator tag affixed to the vehicle detects that the locator tag has been separated from the vehicle;
security means for transmitting a signal when unauthorized movement of said vehicle is detected.

17. The inventory tracking, reconciliation and work flow system according to claim 16, wherein the location means further comprises a plurality of anchors, each anchor being located in an area in which the locator tag and vehicle are expected to be located, and each anchor having a first transceiver for communicating with a transceiver of the locator tag to receive location information, and a second transceiver for communicating with the other anchors to form a resilient network.

18. The inventory tracking, reconciliation and work flow system according to claim 17, wherein the locator tag transceiver and the first transceiver of each of the plurality of anchors are ultra wide band transceivers.

19. The inventory tracking, reconciliation and work flow system according to claim 17, wherein the location means further comprises a base station having a first transceiver for communicating with the second transceivers of the plurality of anchors to receive said location information, and means for relaying said location information to an application for processing said location information.

20. The inventory tracking, reconciliation and work flow system according to claim 19 wherein the second transceiver of each of the plurality of anchors and the first base station transceiver are 2.4 GHz wireless transceivers.

21. The inventory tracking, reconciliation and work flow system according to claim 16, wherein the tamper-resistant means further comprises an adhesive backing having an upper reflective surface engaging the locator tag and a lower surface configured to engage a windshield of the vehicle, wherein said one or more locator tag sensors comprises an infrared emitter and detector facing and tuned to the reflective surface engaging the locator tag to reflect a particular spectrum of light.

22. The inventory tracking, reconciliation and work flow system according to claim 21 further comprising a weatherproof housing encasing the locator tag, a lower section of said housing being disposed between said infrared emitter and detector and said upper reflective surface of the adhesive backing, said lower housing being formed of an infrared transmissive polycarbonate material that allows the emitted infrared light from the infrared emitter to pass through the housing and reflect back from the upper reflective surface.

23. The inventory tracking, reconciliation and work flow system according to claim 22 wherein observation or removal of the adhesive backing is detected by the infrared detector and triggers a notification to the resilient network.

24. The inventory tracking, reconciliation and work flow system according to claim 16, wherein the security means further comprises a plurality of anchors, each anchor having a first transceiver for communicating with a transceiver of the locator tag to receive movement information, and a second transceiver for communicating with the other anchors to form a resilient network.

25. The inventory tracking, reconciliation and work flow system according to claim 24, wherein the locator tag transceiver and the first transceiver of each of the plurality of anchors are ultra wide band transceivers.

26. The inventory tracking, reconciliation and work flow system according to claim 24, wherein the security means further comprises a base station having a first transceiver for communicating with the second transceivers of the plurality of anchors to receive said movement information, and means for relaying said movement information to an application for processing said movement information.

27. The inventory tracking, reconciliation and work flow system according to claim 26 wherein the second transceiver of each of the plurality of anchors and the first base station transceiver are 2.4 GHz wireless transceivers.

28. The inventory tracking, reconciliation and work flow system according to claim 24, wherein the security means further comprises an internal motion sensor associated with each anchor.

29. The inventory tracking, reconciliation and work flow system according to claim 28 wherein the inertial motion sensor comprises a 3-axis accelerometer, a 3-axis gyroscope and a 3-axis magnetometer.

30. The inventory tracking, reconciliation and work flow system according to claim 29 wherein the security means further includes an altimeter/barometer associated with each anchor.

31. The inventory tracking, reconciliation and work flow system according to claim 24 wherein said security means further comprises an internal motion sensor associated with each one or more locator tag sensors.

32. The inventory tracking, reconciliation and work flow system according to claim 31 wherein the inertial motion sensor comprises a 3-axis accelerometer, a 3-axis gyroscope and a 3-axis magnetometer.

33. The inventory tracking, reconciliation and work flow system according to claim 28 wherein the security means further includes an altimeter/barometer associated with each locator tag.
